(19) United States
(12) Patent Application Publication
(10) Pub. No.: US 2017/0171336 A1
(43) Pub. Date: Jun. 15, 2017

(54) METHOD AND ELECTRONIC DEVICE FOR INFORMATION RECOMMENDATION

(71) Applicants: Le Holdings (Beijing) Co., Ltd., Beijing (CN); LE SHI INTERNET INFORMATION & TECHNOLOGY CORP.BEIJING, Beijing (CN)

(72) Inventor: Fei YIN, Beijing (CN)

(21) Appl. No.: 15/250,627

(22) Filed: Aug. 29, 2016

Related U.S. Application Data
(63) Continuation of application No. PCT/CN2016/089101, filed on Jul. 7, 2016.

(30) Foreign Application Priority Data
Dec. 15, 2015 (CN) 201510939595.1

(51) Int. Cl. H04L 29/08; G06F 17/30; H04W 4/02

(52) U.S. Cl. CPC H04L 67/26; H04L 67/22; H04W 4/02; G06F 17/30867

(57) ABSTRACT

A method and an electronic device for information recommendation are disclosed. The method includes: determining, according to history access behaviors of a user on a mobile terminal, preference information corresponding to the user; assigning a weight to an application on the mobile terminal according to the determined preference information and a context node for information recommendation; acquiring application recommendation information sent to the mobile terminal within a predetermined time period; sequencing the acquired application recommendation information according to the assigned weight; and screening a predetermined amount of application recommendation information from the sequenced application recommendation information, and pushing the screened application recommendation information to the mobile terminal.

### CROSS REFERENCE TO RELATED APPLICATIONS

This present disclosure is a continuation of International Application No. PCT/CN2016/089101, filed on Jul. 7, 2016, which is based upon and claims priority to Chinese Patent Application No. 201510939595.1, filed on Dec. 15, 2015, the entire contents of which are incorporated herein by reference.

### TECHNICAL FIELD

The disclosure relates to the field of Internet communications technologies, and more particularly, to a method and an electronic device for information recommendation.

### BACKGROUND

In recent years, with the popularity of smart phones, tablet computers and the like mobile terminals, the mobile Internet has become an indispensable media for users. Mobile phones are not merely basic terminals for communication and information transfer, but have become entertainment application terminals that are carried by the user anytime and anywhere. Such a drastic change promotes the birth of a huge mobile application market. For example, the well-known “Angry Birds” is one of the most populated mobile phone games, which, like the Google snap, has almost become a standard configuration for most smart phone users.

In the meantime, consumption manner, consumption habits and consumption behaviors of the users are accordingly changing: during purchase of services, PC users are different from smart phone users in terms of time, and consumers using mobile terminals are commonly not patient but desire to immediately find their desired products or services. A typical example is that 82% of users who book their rooms using mobile phones would make a decision and accomplish room booking within 24 hours. These users even book their rooms in hotels immediately they arrive at their destinations, and consume less time compared against users who book hotels on personal computers. Such “impulse buying” and “immediate buying” behaviors of the mobile terminal users is a subversion for traditional Internet business mode having a slack pace. With respect to such a new change, enterprises need to help the users to find their interested applications within an extremely short period of time, to seize up opportunities of mobile marketing.

In an e-commerce platform, to maintain user retention, various applications generally select to push advertisement information to the mobile terminals of the users to draw users' attention. The advertisement information may he pushed upon start of the mobile terminals, or may be pushed during running of the mobile terminals.

At present, a commonly used method for recommending information on a mobile terminal is judging whether to push recommendation information to the mobile terminal according to a use state of the mobile terminal. A server responsible for information recommendation may acquire data of communication with the mobile terminal, and then may detect whether the mobile terminal is in a standby state or being currently used. When the mobile terminal is in the standby state, information may he recommended to the mobile terminal,

Another commonly used method for recommending information is pushing information to a mobile terminal at a predetermined time point. A server responsible for information recommendation may predefine a time node for information recommendation, wherein the time node may be, for example, 9:00, 11:00 and 18:00 on each day. Thus, when the system time reaches the predetermined time node, information may be automatically recommended to the mobile terminal.

The above two commonly used methods for recommending information may both effectively push the information to the mobile terminal of the user, to draw the user's attention. However, such information recommendation methods have the following problem: some applications, although present on the mobile terminal of the user, are seldom used by the user. However, upon receiving recommendation information of these applications, the user would generally process the information as spam information. In other words, in the current information recommendation methods, the user is a party who passively receives information, but subjective feeling of the user is not considered. Obviously, such information recommendation methods are inflexible, and fail to effectively enhance user experience.

### SUMMARY

In view of the above, one technical problem to he solved by the present disclosure is to provide an information recommendation method and apparatus for a mobile terminal, such that information may be selectively recommended to a user according to preferences of the user.

The present disclosure provides a method for information recommendation, including:

determining, according to history access behaviors of a user on a mobile terminal, preference information corresponding to the user;

assigning a weight to an application on the mobile terminal according to the determined preference information and a context node for information recommendation;

acquiring application recommendation information sent to the mobile terminal within a predetermined time period;

sequencing the acquired application recommendation information according to the assigned weight; and

screening a predetermined amount of application recommendation information from the sequenced application recommendation information, and pushing the screened application recommendation information to the mobile terminal.

The present disclosure further provides a mobile terminal, including: at least one processor; and a memory communicably connected with the at least one processor for storing instructions executable by the at least one processor, wherein execution of the instructions by the at least one processor causes the at least one processor to:

determine, according to history access behaviors of a user on a mobile terminal, preference information corresponding to the user;

assign a weight to an application on the mobile terminal according to the determined preference information and a context node for information recommendation;

acquire application recommendation information sent to the mobile terminal within a predetermined time period;

sequence the acquired application recommendation information according to the assigned weight; and

screen a predetermined amount of application recommendation information from the sequenced application recommendation information, and push the screened application recommendation information to the mobile terminal.

An embodiment of the present disclosure provides a non-volatile computer-readable storage medium stored with computer executable instructions, the computer executable instructions perform any one of the method for information recommendation described above in the disclosure.

An embodiment of the present disclosure provides an electronic device, including: at least one processor; and a memory; wherein, the memory is communicably connected with the at least one processor and for storing instructions executed by the at least one processor, the computer executable instructions perform any one of the method for information recommendation described above in the disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating an information recommendation method for a mobile terminal according to an embodiment of the present disclosure; and

FIG. 2 is a schematic structural diagram illustrating an information recommendation apparatus for a mobile terminal in terms of functional modules according to an embodiment of the present disclosure.

FIG. 3 is a schematic structural diagram illustrating a mobile terminal according to the present disclosure.

### DETAILED DESCRIPTION

To make the objectives, technical solutions and advantages of the embodiments of the present disclosure clearer, the technical solutions according to the embodiments of the present disclosure are clearly and thoroughly described with reference to the accompanying drawings of the embodiments of the present disclosure. The described embodiments are merely exemplary ones, but are not all the embodiments of the present disclosure. Based on the embodiments of the present disclosure, all other embodiments derived by persons of ordinary skill in the art without any creative efforts shall fall within the protection scope of the present disclosure.

When a user uses a mobile terminal, the user generally has some preferences. For example, if a user is interested in application regarding finance, the user may install a lot of applications regarding finance on his or her mobile terminal. Nevertheless, other applications may also be installed on the mobile terminal, for example, commonly used social networking software and the like. When the user uses the applications installed on the mobile terminal in daily life, use frequencies of the applications are different. Based on this, according to the embodiments of the present disclosure, information may be selectively recommended to the user according to the user's preferences to different applications.

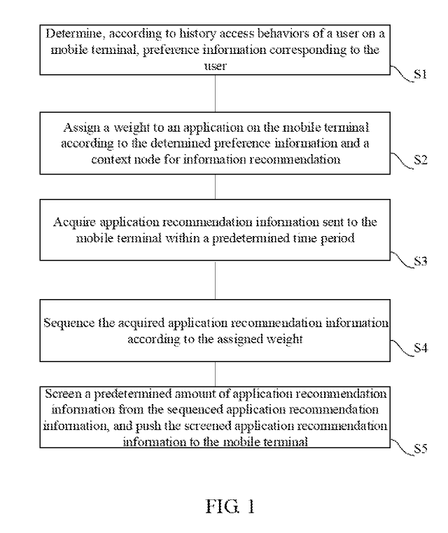

FIG. 1 is a flowchart illustrating an information recommendation method for a mobile terminal according to an embodiment of the present disclosure. Although the processes described below include multiple operations performed in a specific order, it should be clearly understood that these processes may include more or fewer operations and these operations may be executed in sequence or in parallel, for example, using parallel processors or a multi-thread environment.

As illustrated in FIG. 1, the method may include the following steps:

In step S1, preference information corresponding to a user is determined according to history access behaviors of the user on a mobile terminal.

When the user uses the mobile terminal, the mobile terminal may record access times and use duration of each application. In addition, a server corresponding to each application may also record the access times and use duration when the user uses the application. In the embodiment of the present disclosure, the history access behaviors of the user on the mobile terminal may be acquired by accessing the server corresponding to the application. By analyzing history access behaviors of a user on a mobile terminal, preference information corresponding to the user may be acquired. The use frequencies and use durations of the applications in the history access behaviors may be analyzed to thus determine applications which the user is interested in and applications which the user is not interested

In practical application scenarios, the user's use preferences to the applications would vary with the date, environment and location. For example, on December 12, the user would be subjected to discount and promotion information of various merchants, and the use frequencies and durations of application regarding payment would significantly increase. Still for example, on the Spring Festival or Mid-Autumn Festival, the user's use frequencies and durations of social networking applications would also significantly increase. That is, the information to be recommended to the user may be practically determined according to the specific date, environment or location. As such, information desired by the user may be better provided for the user. In an embodiment of the present disclosure, user behavior data fused with context information may be generated according to the history access behaviors of the user on the mobile terminal. For example, from a macro perspective, in the history access behaviors of the user on the mobile terminal, the user is interested in the applications regarding finance; and therefore, the use frequencies and durations of the applications regarding finance are obviously higher than those of the other applications. However, although sonic applications are seldom used or used for a short period of time, use of these applications complies with specific rules. For example, with respect to an application, the user generally uses the application on February 14 each year, and this application is not used any other time. In this case, considering that the date feature that February 14 is the Valentine's Day, this date feature may be fused into the behaviors of the application.

In the embodiment of the present disclosure, the above date feature may be context information of the use behavior, and after the context information is fused to the access behaviors of the user, the behavior data of the user may be more accurately generated. The context information may include at least one of geographic context information, date context information and environment context information. For example, the geographic context information may be understood as follows: when the user is at home, the user is accustomed to using applications regarding social networking; and when the user is outdoor, the user is accustomed to using applications regarding image processing. Still for example, the environment context information may be understood as follows: when the temperature is subjected to an abrupt change, the user is accustomed to using applications regarding to weather reporting.

By analyzing these history access behaviors of the user, context information corresponding to each access behavior may be determined, and thus an association may be established between different access behaviors with different context information, such that preference information corresponding to the user may be more accurately generated.

After user behavior data fused with context information is generated, according to the embodiment of the present disclosure, the user behavior data fused with context information may be subjected to categorization. The categorization is intended to aggregate application programs having similar features into the same application category. For example, Youdao translation, Google translation, Baidu translation and the like applications may be categorized into the category of translation software.

In the embodiment of the present disclosure, such categorization may be implemented by the clustering analysis method. A clustering analysis process refers to an analysis process of grouping sets of physical or abstract objects into a plurality of categories formed of similar objects. In the embodiment of the present disclosure, the K-means categorization method may be employed to categorize the user behavior data fused with context information. According to the embodiment of the present disclosure, some behavior data may be selected as an aggregation point, and then the behavior data within a predetermined range in the vicinity of the aggregation point may be aggregated to the aggregation point by observing the principle of proximity. As such, a plurality of clusters of behavior data may be formed. Subsequently, a central position of each cluster may be calculated, and then the behavior data of the user is re-clustered according to the calculated central position. Such operations are repeated until the position of the aggregation point converges.

In this way, by means of the clustering method, the generated user behavior data fused with context information may be categorized, and finally a preference criterion corresponding to the user may be formed. The preference criterion may be used for differentiating different access behaviors according to different context information, such that the preference criterion may be determined as the preference information corresponding to the user.

In step S2, a weight is assigned to an application on the mobile terminal according to the determined preference information and a context node for information recommendation.

After the preference information corresponding to the user is determined, weights may be assigned to applications on the mobile terminal according to the determined preference information and context nodes for information recommendation. In the embodiment of the present disclosure, each time when the user uses the mobile terminal, the mobile terminal may acquire context information on that day, for example, the current location of the user, the date of that day, the environment on that day and the like. After the context information of the user is acquired, corresponding information may be recommended for the user according to the context information.

According to the embodiment of the present disclosure, a corresponding relationship between use frequencies of applications and context nodes may be extracted from the determined preference information. Then, a use frequency of the application corresponding to the context node for information recommendation may be determined. For example, on February 14, when information is ready for recommendation to the user, a context node corresponding to February 14 may be firstly acquired. Assume that the context node is the Valentine's Day and exceptional temperate change, then it may be queried, according to the use the corresponding relationship between use frequencies of applications and context nodes, that under such context node, the use frequencies of the applications regarding social networking and the applications regarding weather reporting are the highest. In this case, the weights may be assigned to the applications on the mobile terminal according to the determined use frequencies of the applications. An application has the higher use frequency is assigned a higher weight. The weight of an application may be determined according to a ratio of the use frequency of the application in the total frequency.

In step S3, application recommendation information sent to the mobile terminal within a predetermined time period is acquired.

After different weights are assigned to different applications, the application recommendation information sent to the mobile terminal within a predetermined period of time may be acquired. The application recommendation information sent to the mobile terminal may be recommendation information issued by servers of the applications.

According to the embodiment of the present disclosure, the recommendation information may be specifically filtered. After the servers of applications issues recommendation information, the recommendation information may be acquired by the information recommendation apparatus according to the embodiment of the present disclosure. The information recommendation apparatus may be located between the server of the application and the mobile terminal, to achieve an effect of filtering the recommendation information of the mobile terminal.

In step S4, the acquired application recommendation information is sequenced according to the assigned weight.

After the recommendation information issued by the server; of the applications is acquired, according to the embodiment of the present disclosure, the acquired application recommendation information may be sequenced according to the assigned weights. One objective of the sequencing is to screen the recommendation information issued by the servers according to the users preferences.

In step S5, a predetermined amount of application recommendation information is screened from the sequenced application recommendation information, and the screened application recommendation information is pushed to the mobile terminal.

After the recommendation information issued by the servers is sequenced, recommendation information of a predetermined quantity of application recommendation information may be screened from the sequenced application recommendation information, and the screened application recommendation information may be pushed to the mobile terminal.

For example, if the servers issue totally 10 pieces of recommendation information, and the 10 pieces of recommendation information respectively correspond to 10 different applications, then after the recommendation information is sequenced, five pieces of recommendation information having higher weights may be acquired, and the five pieces of recommendation information are sent to the mobile terminal, to prompt the user to use the recommendation information. The other recommendation information may be automatically filtered.

On some occasions, although the recommendation information of the applications has been filtered, still excessive recommendation information is provided for the user. In this case, in an embodiment of the present disclosure, the pushed application recommendation information may be corrected according to feedback information of the user, and the corrected application recommendation information may be pushed to the mobile terminal. In this way, the recommendation information may be more accurately filtered according to the user's preferences.

Accordingly, during information recommendation to the mobile terminal of the user, generally the access behaviors of the user need to be analyzed. However, with respect to masses of user groups, it is a very complicated job to analyze each of the users, which undoubtedly increases load of the entire system. Therefore, in an embodiment of the present disclosure, a preference similarity between users may be considered, such that some recommendation information is sent to a plurality of users who have the same preference or similar preference.

According to the embodiment of the present disclosure, a preference similarity between a first user and a second user may be predetermined. The preference similarity between the first user and the second user may be determined according to the service objects for which the first user and the second user perform a designated operation. According to the embodiment of the present disclosure, description words of the service objects for which the first user and the second user perform the designated operation may be respectively acquired. The designated operations may be flexibly defined according to the practical features of the released service objects. For example, in an application regarding e-commerce, the designated operation may be a purchase operation for a service object a product). The description word of the service object may be a word characterizing the features of the service object, and this word may be stored in the application when the service object is determined. After the description words of the service objects for which the first user and the second user perform the designated operation are acquired, a preference vector of the first user and a preference vector of the second user may be respectively determined. The preference vector may include a plurality of vector elements. Generally, the number of vector elements in the preference vector of the first user is the same as the number of vector elements in the preference vector of the second user. To be specific, the dimensions of the two preference vectors are the same. The vector elements in the preference vector may correspond to various behaviors, for example, access frequency, access time, access date and the like. Subsequently, a similarity between the preference vector of the first user and the preference vector of the second user may be determined as the preference similarity between the first user and the second user. In the embodiment of the present disclosure, the similarity between the preference vector of the first user and the preference vector of the second user may be determined using the following formula:

$$σ = \frac{{\sum }_{k = 1}^{n} ( {x}_{k} - \overline{{x}_{k}} ) ( {y}_{k} - \overline{{y}_{k}} )}{\sqrt{{\sum }_{k = 1}^{n} ( {( {x}_{k} - \overline{{x}_{k}} )}^{2} {( {y}_{k} - \overline{{y}_{k}} )}^{2} )}}$$

wherein σ denotes the similarity between the preference vector of the first user and the preference vector of the second user, xₖ denotes the k^{th} element in the preference vector of the first user, and yₖ denotes the k^{th} element in the preference vector of the second user.

As such, when the preference similarity between the first user and the second user reaches a predetermined threshold, pushing recommendation corresponding to the first user to a mobile terminal of the second user. In this way, the same information is recommended to a plurality of users who have the same preference or similar preference, which reduces load of the entire system.

Accordingly, with the information recommendation method for a mobile terminal according to the embodiments of the present disclosure, by analyzing history access behaviors of a user on a mobile terminal, preference information corresponding to the user may be acquired. The preference information of the user generally varies with the environment, location and time of the user According to the embodiments of the present disclosure, information may be selectively recommended to the user in combination with a context node for information recommendation and according to the preference information of the user.

Considering that analyzing history access behaviors of a single user may increase load of the system, in the embodiments of the present disclosure, a preference similarity between a plurality of users may be analyzed to recommend information of a user to users who have preference information similar to that of the user. In this way, information recommendation may be provided for more users on the basis of analyzing history access behaviors of a small number of user samples, which reduces reorganization load of the system.

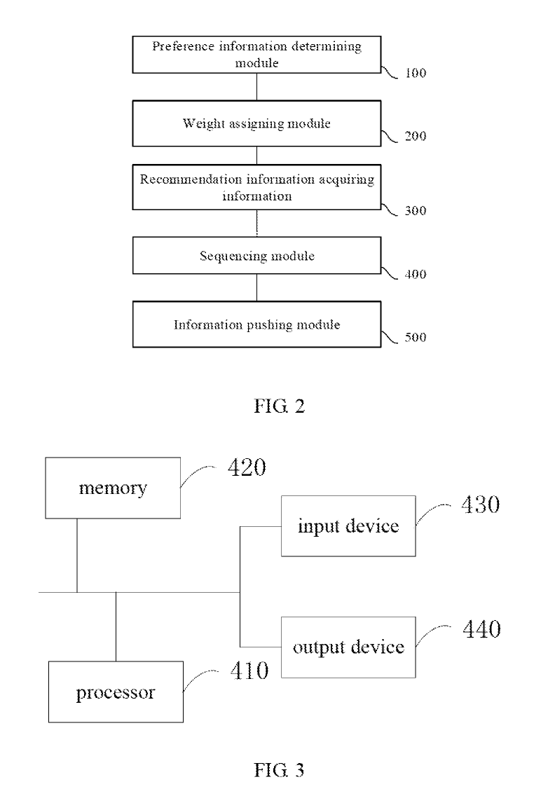

An embodiment of the present disclosure further provides an information recommendation apparatus for a mobile terminal. FIG. 2 is a schematic structural diagram illustrating an information recommendation apparatus for a mobile terminal in terms of functional modules according to an embodiment of the present disclosure

As illustrated in FIG. 2, the apparatus may include:

a preference information determining module 100, configured to determine, according to history access behaviors of a user on a mobile terminal, preference information corresponding to the user;

a weight assigning module 200, configured to assign a weight to an application on the mobile terminal according to the determined preference information and a context node for information recommendation;

a recommendation information acquiring module 300, configured to acquire application recommendation information sent to the mobile terminal within a predetermined time period;

a sequencing module 400, configured to sequence the acquired application recommendation information according to the assigned weight; and

an information pushing module 500, configured to screen a predetermined amount of application recommendation information from the sequenced application recommendation information, and push the screened application recommendation information to the mobile terminal.

In an embodiment of the present disclosure, the preference information determining module 100 includes:

a context fusing module, configured to generate user behavior data fused with context information according to the history access behaviors of the user on the mobile terminal;

a preference criterion constituting module, configured to categorize the generated user behavior data fused with the context information to constitute a preference criterion corresponding to the user; and

a determining module, configured to determine the constituted preference criterion as the preference information corresponding to the user.

In another embodiment of the present disclosure, the weight assigning 200 includes:

a corresponding relationship extracting module, configured to extract a corresponding relationship between use frequencies of applications and context nodes from the determined preference information;

a use frequency determining module, configured to determine a use frequency of the application corresponding to the context node for information recommendation; and

an assigning module, configured to assign the weight to the application on the mobile terminal according to the determined use frequency of the application.

In another embodiment of the present disclosure, in addition to the information pushing module 500, the apparatus further includes:

a correcting module, configured to correct the pushed application recommendation information according to feedback information of the user, and push the corrected application recommendation information to the mobile terminal.

In another embodiment of the present disclosure, in addition to the information pushing module 500, the apparatus further includes:

a preference similarity determining module, configured to determine a preference similarity between a first user and a second user; and

a push judging module, configured to, when the preference similarity between the first user and the second user reaches a predetermined threshold, push recommendation corresponding to the first user to a mobile terminal of the second user.

The preference similarity determining module includes:

a description word acquiring module, configured to respectively acquire description words of service objects for which the first user and the second user perform a designated operation;

a preference vector determining module, configured to respectively determine a preference vector of the first user and a preference vector of the second user based on the description words of the service objects for which the first user and the second user perform the designated operation; and

a similarity determining module, configured to determine a similarity between the preference vector of the first user and the preference vector of the second user as the preference similarity between the first user and the second user.

It should be noted that, implementations of various functional modules in the embodiments of the present disclosure with the descriptions in Steps S1 to S5, which are thus not described herein any further.

Accordingly, with the information recommendation apparatus for a mobile terminal according to the embodiments of the present disclosure, by analyzing history access behaviors of a user on a mobile terminal, preference information corresponding to the user may be acquired. The preference information of the user generally varies with the environment, location and time of the user. According to the embodiments of the present disclosure, information may be selectively recommended to the user in combination with a context node for information recommendation and according to the preference information of the user.

Considering that analyzing history access behaviors of a single user may increase load of the system, in the embodiments of the present disclosure, a preference similarity between a plurality of users may be analyzed to recommend information of a user to users who have preference information similar to that of the user. In this way, information recommendation may be provided for more users on the basis of analyzing history access behaviors of a small number of user samples, which reduces reorganization load of the system.

Another embodiment of the present disclosure further provides a non-transitory computer-readable storage medium storing executable instructions that, when executed by an electronic device, cause the electronic device to: determining, according to history access behaviors of a user on a mobile terminal, preference information corresponding to the user; assigning a weight to an application on the mobile terminal according to the determined preference information and a context node for information recommendation; acquiring application recommendation information sent to the mobile terminal within a predetermined time period; sequencing the acquired application recommendation information according to the assigned weight; and screening a predetermined amount of application recommendation information from the sequenced application recommendation information, and pushing the screened application recommendation information to the mobile terminal.

FIG. 3 is a schematic diagram of hardware structure of an electronic device used to perform the method for information recommendation according to an embodiment of the present disclosure, as shown FIG. 4, the device includes:

One or more processors 410 and a memory 420, FIG. 4 illustrates one processor 410 as an example.

The device for the method for information recommendation may further include an input device 430 and an output device 440.

The processor 410. the memory 420, the input device 430 and the output device 440 may be connected with each other through bus or other forms of connections. FIG. 4 illustrates bus connection as an example.

As a non-volatile computer-readable storage medium, the memory 420 may be configured to store non-volatile software program, non-volatile computer executable program and modules, such as program instructions/modules corresponding to the method for information recommendation according to the embodiments of the disclosure for example, the preference information determining module 100, the weight assigning module 200 as illustrated in FIG. 1. By executing the non-volatile software program, instructions and modules stored in the memory 420, the processor 410 may perform various functional applications of the server and data processing, that is, the method for information recommendation according to the above mentioned embodiments.

The memory 420 may include a program storage area and a data storage area, wherein, the program storage area may be stored with the operating system and applications which are needed by at least one functions, and the data storage area may be stored with data which is created according to use of the device for information recommendation. Further, the memory 420 may include a high-speed random access memory, and may further include non-volatile memory, such as at least one of disk memory device, flash memory device or other types of non-volatile solid state memory device. In some embodiments, optionally, the memory 420 may include memory provided remotely from the processor 410, and such remote memory may be connected with the device for information recommendation through network connections, the examples of the network connections may include but not limited to internet, intranet, LAN (Local Area Network), mobile communication network or combination thereof.

The input device 430 may receive inputted number or character information, and generate key signal input related to the user settings and functional control of the device for information recommendation. The output device 440 may include a display device such as a display screen.

The above one or more modules may he stored in the memory 420, when these modules are executed by the one or more processors 410, the method for information recommendation according to any one of the above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) mobile communication device, characterized in having a function of mobile communication mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console, E-book and smarttoys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the device are merely exemplary, Wherein the unit illustrated as a separated component may be or may not he physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for information recommendation, comprising:
at an electronic device;
determining, according to history access behaviors of a user on a mobile terminal, preference information corresponding to the user;
assigning a weight to an application on the mobile terminal according to the determined preference information and a context node for information recommendation;
acquiring application recommendation information sent to the mobile terminal within a predetermined time period;
sequencing the acquired application recommendation information according to the assigned weight; and
screening a predetermined amount of application recommendation information from the sequenced application recommendation information, and pushing the screened application recommendation information to the mobile terminal.

2. The method according to claim 1, wherein the step of determining, according to history access behaviors of a user on a mobile terminal, preference information corresponding to the user comprises:
generating user behavior data fused with context information according to the history access behaviors of the user on the mobile terminal;
generating the generated user behavior data fused with the context information. to constitute a preference criterion corresponding to the user; and
determining the constituted preference criterion as the preference information corresponding to the user.

3. The method according to claim 2, wherein the context information comprises at least one of geographic context information, date context information and environment context information.

4. The method according to claim 1, wherein the step of assigning a weight to an application on the mobile terminal according to the determined preference information and a context node of information recommendation comprises:
extracting a corresponding relationship between use frequencies of applications and context nodes from the determined preference information;
determining a use frequency of the application corresponding to the context node for information recommendation; and
assigning the weight to the application on the mobile terminal according to the determined use frequency of the application.

5. The method according to claim 1, wherein upon the step of pushing the screened application recommendation information to the mobile terminal, the method further comprises:
correcting the pushed application recommendation information according to feedback information of the user, and pushing the corrected application recommendation information to the mobile terminal.

6. The method according to claim 1, wherein upon the step of pushing the screened application recommendation information to the mobile terminal, the method further comprises:
determining a preference similarity between a first user and a second user; and
when the preference similarity between the first user and the second user reaches a predetermined threshold, pushing recommendation corresponding to the first user to a mobile terminal of the second user.

7. The method according to claim 6, wherein the step of determining a preference similarity between a first user and a second user comprises:
respectively acquiring description words of service objects for which the first user and the second user perform a designated operation;
respectively determining a preference vector of the first user and a preference vector of the second user based on the description words of the service objects for which the first user and the second user perform the designated operation; and
determining a similarity between the preference vector of the first user and the preference vector of the second user as the preference similarity between the first user and the second user.

8. The method according to claim 7, wherein the similarity between the preference vector of the first user and the preference vector of the second user is determined using the following formula:
$$σ = \frac{{\sum }_{k = 1}^{n} ( {x}_{k} - \overline{{x}_{k}} ) ( {y}_{k} - \overline{{y}_{k}} )}{\sqrt{{\sum }_{k = 1}^{n} ( {( {x}_{k} - \overline{{x}_{k}} )}^{2} {( {y}_{k} - \overline{{y}_{k}} )}^{2} )}}$$
wherein σ denotes the similarity between the preference vector of the first user and the preference o of the second user, xₖ denotes the k^{th} element in the preference vector of the first user, and yₖ denotes the k^{th} element in the preference vector of the second user.

9. An electronic device, comprising: at least one processor; and a memory communicably connected with the at least one processor for storing instructions executable by the at least one processor, wherein execution of the instructions by the at least one processor causes the at least one processor to:
determine, according to history access behaviors of a user on a mobile terminal, preference information corresponding to the user;
assign a weight to an application on the mobile terminal according to the determined preference information and a context node for information recommendation;
acquire application recommendation information sent to the mobile terminal within a predetermined time period;
sequence the acquired application recommendation information according to the assigned weight; and
screen a predetermined amount of application recommendation information from the sequenced application recommendation information, and push the screened application recommendation information to the mobile terminal.

10. The electronic device according to claim 9, wherein the instructions to determine, according to history access behaviors of a user on a mobile terminal, preference information corresponding to the user cause the at least one processor to:
generate user behavior data fused with context information according to the history access behaviors of the user on the mobile terminal;
generate the generated user behavior data fused with the context information to constitute a preference criterion corresponding to the user; and
determine the constituted preference criterion as the preference information corresponding to the user.

11. The electronic device according to claim 9, wherein the context information comprises at least one of geographic context information, date context information and environment context information.

12. The electronic device according to claim 9, wherein the instructions to assign a weight to an application on the mobile terminal according to the determined preference information and a context node of information recommendation cause the at least one processor to:
extract a corresponding relationship between use frequencies of applications and context nodes from the determined preference information;
determine a use frequency of the application corresponding to the context node for information recommendation; and
assign the weight to the application on the mobile terminal according to the determined use frequency of the application.

13. The electronic device according to claim 9, wherein upon the instructions to push the screened application recommendation information to the mobile terminal, the instructions further cause the at least one processor to:
correct the pushed application recommendation information according to feedback information of the user, and pushing the corrected application recommendation information to the mobile terminal.

14. The electronic device according to claim 9, wherein upon the instructions to push the screened application recommendation information to the mobile terminal, the instructions further caused at least one processor to:
determine a preference similarity between a first user and a second user; and
when the preference similarity between the first user and the second user reaches a predetermined threshold, push recommendation corresponding to the first user to a mobile terminal of the second user.

15. The electronic device according to claim 9, wherein the instructions to determine a preference similarity between a first user and a second user cause the at least one processor to:
respectively acquire description words of service objects for which the first user and the second user perform a designated operation;
respectively determine a preference vector of the first user and a preference vector of the second user based on the description words of the service objects for which the first user and the second user perform the designated operation; and
determine a similarity between the preference vector of the first user and the preference vector of the second user as the preference similarity between the first user and the second user.

16. The electronic device according to claim 9, wherein the similarity between the preference vector of the first user and the preference vector of the second user is determined using the following formula:
$$σ = \frac{{\sum }_{k = 1}^{n} ( {x}_{k} - \overline{{x}_{k}} ) ( {y}_{k} - \overline{{y}_{k}} )}{\sqrt{{\sum }_{k = 1}^{n} ( {( {x}_{k} - \overline{{x}_{k}} )}^{2} {( {y}_{k} - \overline{{y}_{k}} )}^{2} )}}$$
wherein σ denotes the similarity between the preference vector of the first user and the preference vector of the second user, xₖ denotes the k^{th} element in the preference vector of the first user, and yₖ denotes the k^{th} element in the preference vector of the second user.

17. A non-transitory computer-readable storage medium storing executable instructions that, when executed by an electronic device with a touch-sensitive display, cause the electronic device to:
determine according to history access behaviors of a user on a mobile terminal, preference intonation corresponding to the user;
assign a weight to an application on the mobile terminal according to the determined preference information and a context node for information recommendation;
acquire application recommendation information sent to the mobile terminal within a predetermined time period;
sequence the acquired application recommendation information according to the assigned weight; and
screen a predetermined amount of application recommendation information from the sequenced application recommendation information. and pushing the screened application recommendation information to the mobile terminal.

18. The non-transitory computer-readable storage medium according to claim 17 wherein the instructions to determine, according to history access behaviors of a user on a mobile terminal, preference information corresponding to the user cause the electronic device to:
generate user behavior data fused with context information according to the history access behaviors of the user on the mobile terminal;
generate the generated user behavior data fused with the context information to constitute a preference criterion corresponding to the user; and
determine the constituted preference criterion as the preference information corresponding to the user.

19. The non-transitory computer-readable storage medium according to claim 17, wherein the context information comprises at least one of geographic context information, date context information and environment context information.

20. The non-transitory computer-readable storage medium according to claim 17, wherein the instructions to assign a weight to an application on the mobile terminal according to the determined preference information and a context node of information recommendation cause the electronic device to:
extract a corresponding relationship between use frequencies of applications and context nodes from the determined preference information;
determine a use frequency of the application corresponding to the context node for information recommendation; and
assign the weight to the application on the mobile terminal according to the determined use frequency of the application.

21. The non-transitory computer-readable storage medium according to claim 17, wherein upon the instructions to push the screened application recommendation information to the mobile terminal, the instructions further cause the electronic device to:
correct the pushed application recommendation information according to feedback information of the user, and pushing the corrected application recommendation information to the mobile terminal.

22. The non-transitory computer-readable storage medium according to claim 17, wherein upon the instructions to push the screened application recommendation information to the mobile terminal, the instructions further cause the electronic device to:
determine a preference similarity between a first user and a second user; and
when the preference similarity between the first user and the second user reaches a predetermined threshold, push recommendation corresponding to the first user to a mobile terminal of the second user.

23. The non-transitory computer-readable storage medium according to claim 17, wherein the instructions to determine a preference similarity between a first user and a second user cause the electronic device to:
respectively acquire description words of service objects for Which the first user and the second user perform a designated operation;
respectively determine a preference vector of the first user and a preference vector of the second user based on the description words of the service objects for which the first user and the second user perform the designated operation; and
determine a similarity between the preference vector of the first user and the preference vector of the second user as the preference similarity between the first user and the second user.

24. The non-transitory computer-readable storage medium according to claim 17, wherein the similarity between the preference vector of the first user and the preference vector of the second user is determined using the following formula:
$$σ = \frac{{\sum }_{k = 1}^{n} ( {x}_{k} - \overline{{x}_{k}} ) ( {y}_{k} - \overline{{y}_{k}} )}{\sqrt{{\sum }_{k = 1}^{n} ( {( {x}_{k} - \overline{{x}_{k}} )}^{2} {( {y}_{k} - \overline{{y}_{k}} )}^{2} )}}$$
wherein σ denotes the similarity between the preference vector of the first user and the preference vector of the second user, xₖ denotes the k^{th} element in the preference vector of the first user, and yₖ denotes the k^{th} element in the preference vector of the second user.
